(19) United States
(12) Patent Application Publication
(10) Pub. No.: US 2007/0039947 A1
(43) Pub. Date: Feb. 22, 2007

(54) Power multipliers

(76) Inventor: Richard W. Cann, Boston, MA (US)

Correspondence Address: RICHARD W. CANN, 533 E. EIGHTH ST., BOSTON, MA, 02127, US

(21) Appl. No.: 11/126,834

(22) Filed: Jul. 11, 2005

(51) Int. Cl. H05B 3/02

(52) U.S. Cl. 219/508

(57) ABSTRACT

This heating unit consists one furnace motor (¼ hp), three auto generators and three oil filled Electric Radiators Heaters and a Thermostat single stage heat/cool.

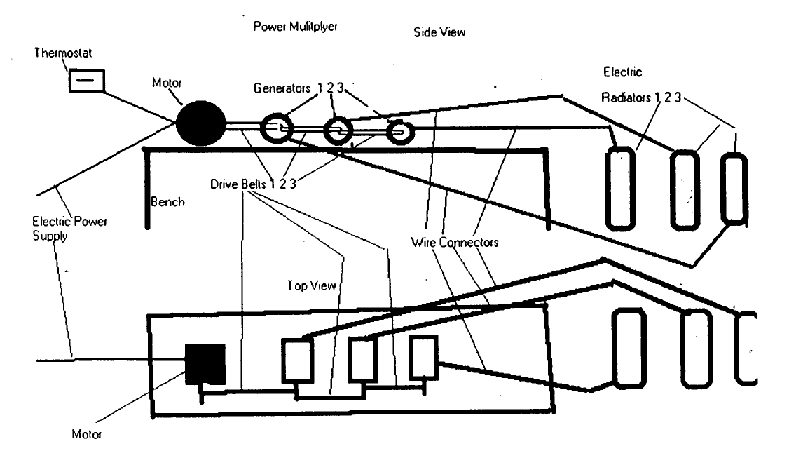

This is a Space heating unit, it is much cheaper to operate than gas or other electric Heaters.

The invention consist of a ¼ hp Furnace motor which is controlled by an on off thermostat. When the temperature drops below the set temperature the motor start turning and it turns the three generators by drive belts it is driving three generators. The generators output from each of the three generators is fed to a Oil-filled Electric Radiator by by one of the three electric wires.

These units are much cheaper than other electric heater units because only the electric motor is on the electric meter being charged to the power utility. You are generating your own electricity to create the heat from the radiators.

1. This Power Multiplier is very cheap to operate because it manufactures its own electricity and is only charged for the electric motor that drives the small generators it turns to create its electricity. Also by using small generators it's safer than using larger generators, and there is no air pollution caused by the heat created.
